(19) United States
(12) Patent Application Publication
(10) Pub. No.: US 2025/0104468 A1
(43) Pub. Date: Mar. 27, 2025

(54) INFORMATION PROCESSING APPARATUS, INFORMATION PROCESSING METHOD, AND RECORDING MEDIUM

(71) Applicant: NEC Corporation, Minato-ku, Tokyo (JP)

(72) Inventor: Masato Tsukada, Tokyo (JP)

(73) Assignee: NEC Corporation, Minato-ku, Tokyo (JP)

(21) Appl. No.: 18/728,165

(22) PCT Filed: Mar. 16, 2022
(86) PCT No.: PCT/JP2022/011913

§ 371 Date: Jul. 11, 2024

(51) Int. Cl. G06V 40/16; G06V 10/25; G06V 10/60; G06V 40/18

(52) U.S. Cl. CPC G06V 40/171; G06V 10/25; G06V 10/60; G06V 40/193; G06V 40/197

(57) ABSTRACT

An information processing apparatus includes: a setting unit that sets an evaluation area in a target image including at least a body of a target, for evaluating a focus degree of a body area including a part of the body of the target; and a determination unit that determines whether or not the target image is a focused image in which the body area is in focus, on the basis of variance of luminance values of a plurality of pixels included in the evaluation area.

### TECHNICAL FIELD

This disclosure relates to technical fields of an information processing apparatus, an information processing method, and a recording medium that are configured to determine whether or not a target image including at least a body of a target is a focused image in which a body area including a part of the body of the target is in focus, for example. Furthermore, the present disclosure relates to technical fields of an information processing apparatus, an information processing method, and a recording medium that are configured to authenticate the target by using the target image including at least the body of the target, for example.

### BACKGROUND ART

Patent Literature 1 describes an example of an information processing apparatus that is configured to authenticate a target by using a target image including a body of the target. Especially, the information processing apparatus described in Patent Literature 1 uses an image outputted from an image photographing apparatus to authenticate a person to be authenticated. The image photographing apparatus described in Patent Literature 1 includes: an image photographing unit that captures images at position with different photographing distances, by imaging the person to be authenticated; a focus degree calculation unit that calculates a focus degree of the image captured by the image photographing unit; and a focused image determination unit that determines whether or not the image captured by the image photographing unit is a focused image by determining whether or not the focus degree is greater than or equal to a predetermined threshold.

In addition, as prior art documents related to this disclosure, Patent Literature 2, Patent Literature 3, and Patent Literature 4 are cited.

### CITATION LIST

### Patent Literature

Patent Literature 1: JP2004-328367A
Patent Literature 2: JP2007-093874A
Patent Literature 3: JP2016-534474A
Patent Literature 4: JP2017-201303A

### SUMMARY

### Technical Problem

It is an example object of this disclosure to provide an information processing apparatus, an information processing method, and a recording medium that are intended to improve the techniques/technologies described in Citation List.

### Solution to Problem

An information processing apparatus according to a first example aspect of this disclosure includes: a setting unit that sets an evaluation area in a target image including at least a body of a target, for evaluating a focus degree of a body area including a part of the body of the target; and a determination unit that determines whether or not the target image is a focused image in which the body area is in focus, on the basis of variance of luminance values of a plurality of pixels included in the evaluation area.

An information processing method according to a first example aspect of this disclosure includes: setting an evaluation area in a target image including at least a body of a target, for evaluating a focus degree of a body area including a part of the body of the target; and determining whether or not the target image is a focused image in which the body area is in focus, on the basis of variance of luminance values of a plurality of pixels included in the evaluation area.

A recording medium according to a first example aspect of this disclosure is a recording medium on which a computer program that allows a computer to execute an information processing methods is recorded, the information processing method including: setting an evaluation area in a target image including at least a body of a target, for evaluating a focus degree of a body area including a part of the body of the target; and determining whether or not the target image is a focused image in which the body area is in focus, on the basis of variance of luminance values of a plurality of pixels included in the evaluation area.

An information processing apparatus according to a second example aspect of this disclosure includes: a setting unit that sets an evaluation area in a target image including at least a body of a target, for evaluating a focus degree of a body area including a part of the body of the target; a determination unit that determines whether or not the target image is a focused image in which the body area is in focus, on the basis of variance of luminance values of a plurality of pixels included in the evaluation area; and an authentication unit that authenticates the target by using the target image that is determined to be the focused image.

An information processing method according to a second example aspect of this disclosure includes: setting an evaluation area in a target image including at least a body of a target, for evaluating a focus degree of a body area including a part of the body of the target; determining whether or not the target image is a focused image in which the body area is in focus, on the basis of variance of luminance values of a plurality of pixels included in the evaluation area; and authenticating the target by using the target image that is determined to be the focused image.

A recording medium according to a second example aspect of this disclosure is a recording medium on which a computer program that allows a computer to execute an information processing methods is recorded, the information processing method including: setting an evaluation area in a target image including at least a body of a target, for evaluating a focus degree of a body area including a part of the body of the target; determining whether or not the target image is a focused image in which the body area is in focus, on the basis of variance of luminance values of a plurality of pixels included in the evaluation area; and authenticating the target by using the target image that is determined to be the focused image.

### BRIEF DESCRIPTION OF DRAWINGS

FIG. 1 is a block diagram illustrating a configuration of an information processing apparatus according to a first example embodiment.

FIG. 2 is a block diagram illustrating a configuration of an information processing apparatus according to a modified example of the first example embodiment.

FIG. 3 is a block diagram illustrating a configuration of an information processing apparatus according to a second example embodiment.

FIG. 4 is a block diagram illustrating a configuration of an information processing apparatus according to a modified example of the second example embodiment.

FIG. 5 is a block diagram illustrating a configuration of an authentication system in a third example embodiment.

FIG. 6 is a block diagram illustrating a configuration of an information processing apparatus according to a third example embodiment.

FIG. 7 is a flowchart illustrating a flow of an authentication operation (especially, an authentication operation including an in-focus determination operation) performed by the information processing apparatus according to the third example embodiment.

FIG. 8A schematically illustrates that a positional relation changes between a focal plane of an imaging apparatus and a target person as the target person moves relative to the imaging apparatus, FIG. 8B schematically illustrates that the positional relation changes between the focal plane of the imaging apparatus and the target person as the imaging apparatus moves relative to the target person, and FIG. 8C schematically illustrates that the positional relation changes between the focal plane of the imaging apparatus and the target person by changing a focal length of the imaging apparatus.

FIG. 9 illustrates a focus evaluation area set for an eye image.

FIG. 10A illustrates a focused image identified by using a first in-focus determination condition that a focus evaluation value (variance) is greater than a predetermined threshold, and FIG. 10B illustrates a focused image identified by using a second in-focus determination condition that the focus evaluation value (variance) is maximal.

Each of FIG. 11A to FIG. 11D illustrates a focus evaluation area set by an information processing apparatus (an in-focus determination unit) according to a fourth example embodiment.

FIG. 12 illustrates a focus evaluation area set by an information processing apparatus (an in-focus determination unit) according to a fifth example embodiment.

FIG. 13 illustrates an imaging apparatus that is configured to change an imaging range.

FIG. 14 illustrates an eye image generated by the imaging apparatus imaging a target person before changing the imaging range, and an eye image generated by the imaging apparatus imaging the target people after changing the imaging range

FIG. 15 is a block diagram illustrating a configuration of an authentication system in a seventh example embodiment.

FIG. 16 illustrates an eye image generated by the imaging apparatus imaging the target person before changing a lighting condition, and an eye image generated by the imaging apparatus imaging the target person after changing the lighting condition.

### DESCRIPTION OF EXAMPLE EMBODIMENTS

Hereinafter, with reference to the drawings, an information processing apparatus, an information processing method, and a recording medium according to example embodiments will be described.

### (1) First Example Embodiment

First, a first example embodiment of an information processing apparatus, an information processing method, and a recording medium will be described. With reference to FIG. 1, the following describes the first example embodiment of the information processing apparatus, the information processing method, and the recording medium, by using an information processing apparatus 1000 to which the first example embodiment of the information processing apparatus, the information processing method, and the recording medium is applied. FIG. 1 is a block diagram illustrating a configuration of the information processing apparatus 1000 according to the first example embodiment.

As illustrated in FIG. 1, the information processing apparatus 1000 according to the first example embodiment includes a setting unit 1001 that is a specific example of the “setting unit” described later in Supplementary Note, and a determination unit 1002 that is a specific example of the “determination unit” described later in Supplementary Note. The setting unit 1001 sets an evaluation area in a target image including at least a body of a target. The evaluation area is an area for evaluating a focus degree of a body area including a part of the body of the target, of the target image. In the example embodiment, “focus/focusing” may mean a state in which an “imaging apparatus that images the target to generate a target image, is focused on the target (especially, a part of the body of the target)”. Based on a variance of luminance values of a plurality of pixels included in the evaluation area, the determination unit 1002 determines whether or not the target image is a focused image in which the body area is in focus. The information processing apparatus 1000 capable of determining whether or not the target image is a focused image, may be referred to as an in-focus determination apparatus.

The information processing apparatus 1000 according to the first example embodiment is capable of determining whether or not the target image is a focused image with higher accuracy than that in a case where it is determined whether or not the target image is a focused image by using an evaluation parameter that is different from the variance of the luminance values of the plurality of pixels included in the evaluation area. In a case where the target image is a focused image, the body of the target is clearly visible in the target image. That is, the body of the target is captured in the target image in a relatively high contrast condition. On the other hand, in a case where the target image is not a focused image, the body of the target is blurred or out of focus in the target image, and the body of the target is in a relatively low contrast condition. Therefore, in a case where the target image is a focused image, the variation (variance) of the luminance values of the plurality of pixels is greater than that in a case where the target image is not a focused image. Based on this property, the luminance values of the plurality of pixels are available as parameters for determining whether or not the target image is a focused image. Thus, the luminance values of the plurality of pixels may be used as parameters for evaluating the focus degree of the body area included in the target image. Consequently, the information processing apparatus 1000 is capable of determining whether or not the target image is a focused image with higher accuracy. Therefore, the information processing apparatus 1000 is capable of solving a technical problem of a reduction in accuracy of determining whether or not the target image is a focused image.

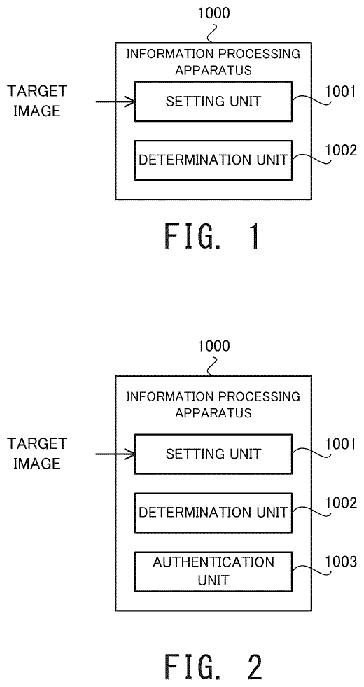

As illustrated in FIG. 2 illustrating the information processing apparatus 1000 according to a modified example of the first example embodiment, the information processing apparatus 1000 may include an authentication unit 1003 that is a specific example of the “authentication unit” described later in Supplementary Note. The authentication unit 1003 may authenticate the target by using the target image that is determined to be a focused image by the determination unit 1002. For example, the authentication unit 1003 may perform biometric authentication of authenticating the target by using a part of the body of the target included in the target image that is determined to be a focused image. As an example, the authentication unit 1003 may perform iris recognition of authenticating the target by using an iris of the target included in the target image that is determined to be a focused image, for example. As another example, the authentication unit 1003 may perform face recognition of authenticating the target by using a face of the target included in the target image that is determined to be a focused image, for example. In this case, the information processing apparatus 1000 is capable of authenticating the target with higher accuracy than that in a case where the target is authenticated by using the target image that is not a focused image. That is, accuracy of authenticating the target is improved. The information processing apparatus 1000 that is configured to authenticate the target (e.g., the information processing apparatus 1000 including the authentication unit 1003) may be referred to as an authentication apparatus.

### (2) Second Example Embodiment

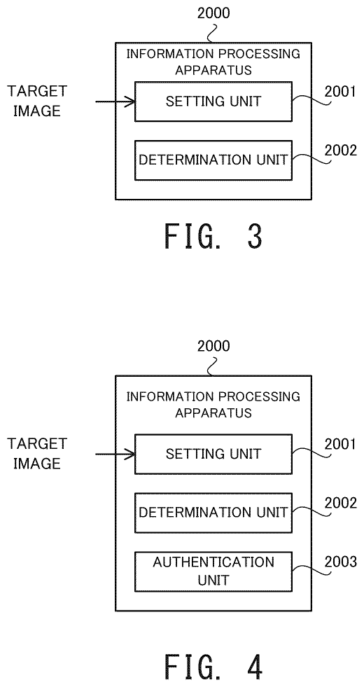

Next, a second example embodiment of an information processing apparatus, an information processing method, and a recording medium will be described. With reference to FIG. 3, the following describes the second example embodiment of the information processing apparatus, the information processing method, and the recording medium, by using an information processing apparatus 2000 to which the second example embodiment of the information processing apparatus, the information processing method, and the recording medium is applied. FIG. 3 is a block diagram illustrating a configuration of the information processing apparatus 2000 according to the second example embodiment.

As illustrated in FIG. 3, the information processing apparatus 2000 according to the second example embodiment includes a setting unit 2001 that is a specific example of the “setting unit” described later in Supplementary Note and a determination unit 2002 that is a specific example of the “determination unit” described later in Supplementary Note. The setting unit 2001 sets the evaluation area in the target image including at least the body of the target. The evaluation area in the second example embodiment is, as in the evaluation area in the first example embodiment, an area for evaluating the focus degree of the body area including a part of the body of the target, of the target image. Especially in the second example embodiment, the target image includes an eye image including an eye of the targets as the body of the target. In addition, the body area includes an iris area including an iris of the target as a part of the body of the target. In this case, the setting unit 2001 sets, as the evaluation area, an area that is included in an iris area and that is different from a pupil area including a pupil of the target and from a reflection area including a reflected image of light entering the eye of the target, in the eye image. Therefore, in the second example embodiment, the evaluation area is included in the iris area, but does not include at least one of the pupil area and the reflection area. The determination unit 2002 calculates an evaluation value for evaluating a focus degree of the iris area by using the evaluation area. The determination unit 2002 may calculate, as the evaluation value, the “variance of the luminance values of the plurality of pixels included in the evaluation area” described in the first example embodiment. In this instance, the “variance of the luminance values of the plurality of pixels included in the evaluation area” described in the first example embodiment may be regarded as a specific example of the “evaluation value” in the second example embodiment. Alternatively, the determination unit 2002 may calculate, as the evaluation value, an evaluation value that is different from the “variance of luminance values of the plurality of pixels included in the evaluation area” described in the first example embodiment. The determination unit 2002 further determines whether or not the eye image is a focused image in which the iris area is in focus, on the basis of the calculated evaluation value. The information processing apparatus 2000 capable of determining whether or not the target image (the eye image in the second example embodiment) is a focused image, may be referred to as an in-focus determination apparatus.

The information processing apparatus 2000 according to the second example embodiment calculates the evaluation value for evaluating the focus degree of the iris area (i.e., the body area) by using the evaluation area excluding the pupil area and the reflection area. That is, the information processing apparatus 2000 determines whether or not the eye image is a focused image (i.e., whether or not the target image is a focused image) by using the evaluation area excluding the pupil area and the reflection area. For this reason, the information processing apparatus 2000 is capable of determining whether or not the eye image is a focused image with higher accuracy than that in a case where it is determined whether or not the eye image is a focused image by using the evaluation area including at least one of the pupil area and the reflection area. The pupil area is generally much darker than the iris area. Therefore, in a case where the evaluation area includes the pupil area, the accuracy of determining whether or not the eye image is a focused image, may be reduced due to the fact that the evaluation area includes the pupil area that is much darker than the iris area. Similarly, the reflection area is generally much brighter than the iris area. Therefore, in a case where the evaluation area includes the reflection area, the accuracy of determining whether or not the eye image is a focused image, may be reduced due to the fact that the evaluation area includes the reflection area that is much brighter than the iris area. In the second example embodiment, however, since the evaluation area does not include the pupil area and the reflection area, there is not a technical problem of a reduction in the accuracy of determining whether or not the eye image is a focused image due to the fact that at least one of the pupil area and the reflection area is included in the evaluation area. Therefore, the information processing apparatus 2000 is capable of solving the technical problem of a reduction in the accuracy of determining whether or not the eye image is a focused image.

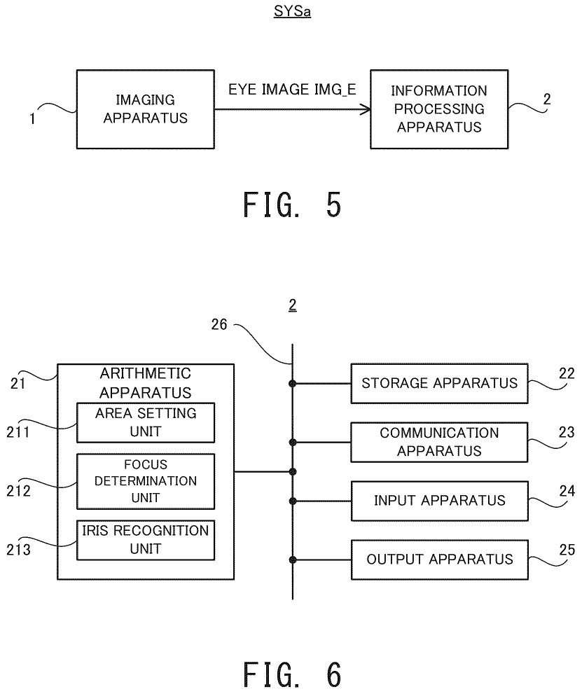

As illustrated in FIG. 4 illustrating the information processing apparatus 2000 according to a modified example of the second example embodiment, the information processing apparatus 2000 may include an authentication unit 2003 that is a specific example of the “authentication unit” described later in Supplementary Note. The authentication unit 2003 may authenticate the target by using the eye image that is determined to be a focused eye image by the determination unit 2002. For example, the authentication unit 2003 may perform iris recognition of authenticating the target by using the iris of the target included in the eye image that is determined to be a focused image. In this case, the information processing apparatus 2000 is capable of authenticating the target with higher accuracy than that in a case where the target is authenticated by using the eye image that is not a focused image. That is, the accuracy of authenticating the target is improved. The information processing apparatus 2000 that is configured to authenticate the target (e.g., the information processing apparatus 2000 including the authentication unit 2003) may be referred to as an authentication apparatus.

### (3) Third Example Embodiment

Next, a third example embodiment of an information processing apparatus, an information processing method, and a recording medium will be described. The following describes the third example embodiment of the information processing apparatus, the information processing method, and the recording medium, by using an authentication system SYS to which the third example embodiment of the information processing apparatus, the information processing method, and the recording medium is applied.

### (3-1) Overall Configuration of Authentication System SYS in Third Example Embodiment

First, with reference to FIG. 5, an overall configuration of the authentication system SYS in the third example embodiment will be described. FIG. 5 is a block diagram illustrating the overall configuration of the authentication system SYS in the third example embodiment.

As illustrated in FIG. 5, the authentication system SYS includes an imaging apparatus 1 and an information processing apparatus 2. The imaging apparatus 1 and the information processing apparatus 2 are configured to communicate with each other through a communication network 3. The communication network 3 may include a wired communication network. The communication network 3 may include a wireless communication network. The imaging apparatus 1 and the information processing apparatus 2, however, may be integrated. That is, the authentication system SYS may be an apparatus in which the imaging apparatus 1 and the information processing apparatus 2 are integrated.

The imaging apparatus 1 is an apparatus that is configured to image at least a part of the target (a so-called camera). The target may include, for example, a human being. The target may include an animal that is different from the human being (e.g., at least one of mammals such as dogs and cats, birds such as sparrow, reptiles such as snakes, amphibians such as frogs, and fishes such as goldfish). The target may include inanimate objects. The inanimate objects may include a robot that imitates a human being or an animal. The following describes a case where the target is a human being (hereinafter referred to as a “target person P”).

The imaging apparatus 1 is configured to generate a person image IMG in which at least a part of the target person P is captured, by imaging at least a part of the target person P. Specifically, the imaging apparatus 1 is configured to generate a person image IMG including the body of the target person P by imaging the body of the target person P. For example, the imaging apparatus 1 may generate a person image IMG including a face of the target person P as the body of the target person P, by imaging the face of the target person P. That is, the imaging apparatus 1 may generate the person image IMG in which the face of the target person P is captured, by imaging the face of the target person P. For example, the imaging apparatus 1 may generate a person image IMG including an eye of the target person P as the body of the target person P by imaging the eye of the target person P. That is, the imaging apparatus 1 may generate the person image IMG in which the eye of the target person P is captured, by imaging the eye of the target person P. The third example embodiment describes an example in which the imaging apparatus 1 is capable of generating, as the person image IMG, an eye image IMG_E in which the eye of the target person P is captured, by imaging the eye of the target person P.

The eye image IMG_E may include a part of the target person P that is different from the eye. Even in this case, as described in detail later, the target person P is authenticated by using the iris of the target person P captured in the eye image IMG_E as a part of the body of the target person P, and thus, there is no problem even if a part of the target person P that is different from the eye is captured in the iris image IMG_I.

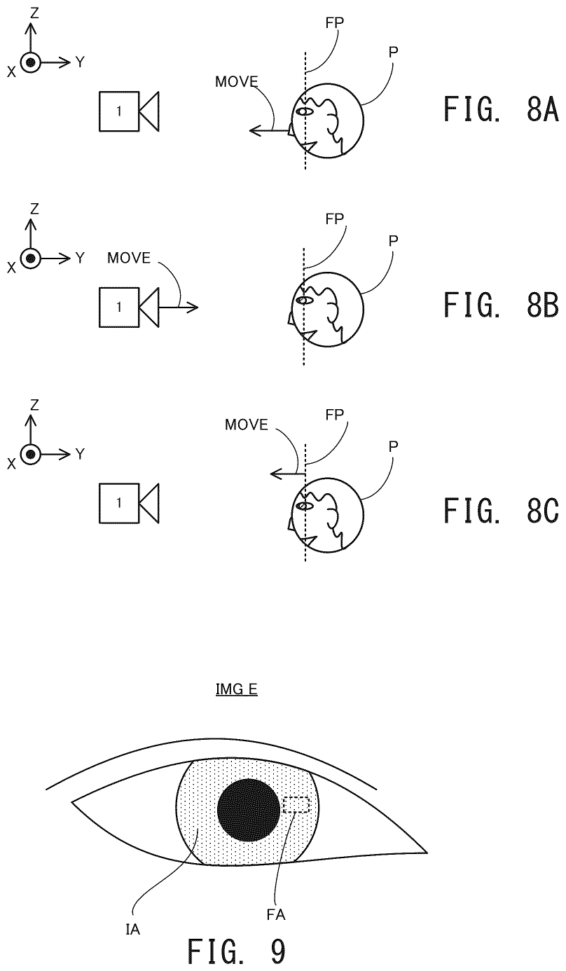

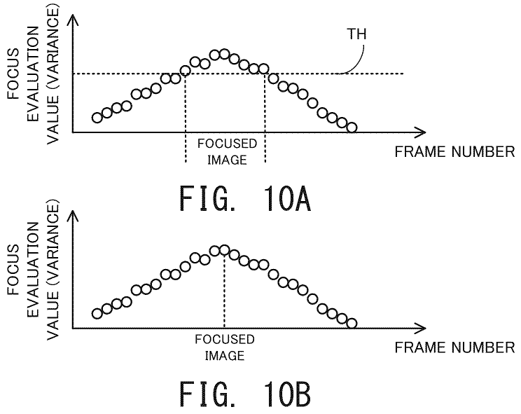

The information processing apparatus 2 acquires the person image IMG from the imaging apparatus 1 and performs an authentication operation for authenticating the target person P by using the person image IMG. Therefore, the information processing apparatus 2 may be referred to as an authentication apparatus. In the third example embodiment, the information processing apparatus 2 acquires the eye image IMG_E from the imaging apparatus 1 and performs the authentication operation for authenticating the target person P by using the eye image IMG_E. Especially, the information processing apparatus 2 performs the authentication operation regarding the iris recognition. Specifically, the information processing apparatus 2 identifies an iris area IA (see FIG. 9 described later) including the iris of the target person P as a part of the body of the target person P, from the acquired eye image IMG_E. The information processing apparatus 2 extracts a feature of the iris (i.e., a feature of a pattern of the iris) from the identified iris area IA. The information processing apparatus 2 determines whether or not the target person P captured in the acquired eye image IMG_E is the same as a previously registered person (hereinafter referred to as a “registrant”) on the basis of the extracted feature of the iris. When it is determined that the target person P captured in the eye image IMG_E is the same as the registrant, it is determined that authentication of the target person P is successful. On the other hand, when it is determined that the target person P captured in the eye image IMG_E is not the same as the registrant, it is determined that the authentication of the target person P is failed.

The information processing apparatus 2 further performs an in-focus determination operation of determining whether or not the eye image IMG_E is a focused image, as a part of the authentication operation. The focused image may mean an image in which the iris area is in focus. Therefore, the information processing apparatus 2 may be referred to as an in-focus determination apparatus. The information processing apparatus 2 authenticates the target person P by using the eye image IMG_E that is determined to be a focused image by the in-focus determination operation. Consequently, the information processing apparatus 2 is capable of authenticating the target person P with higher accuracy than that in a case where the target person P is authenticated by using the eye image IMG_E that is not a focused image (i.e., the eye image IMG_E in which the iris area IA is not in focus). That is, as compared with a case where the target person P is authenticated by using the eye image IMG_E that is not a focused image, the authentication accuracy of the information processing apparatus 2 is improved.

### (3-2) Configuration of Information Processing Apparatus 2 in Third Example Embodiment

Next, a configuration of the information processing apparatus 2 according to the third example embodiment will be described with reference to FIG. 6. FIG. 6 is a block diagram illustrating the configuration of the information processing apparatus 2 according to the third example embodiment.

As illustrated in FIG. 6, the information processing apparatus 2 includes an arithmetic apparatus 21 and a storage apparatus 22. Furthermore, the information processing apparatus 2 may include a communication apparatus 23, an input apparatus 24, and an output apparatus 25. The information processing apparatus 2, however, may not include at least one of the communication apparatus 23, the input apparatus 24, and the output apparatus 25. The arithmetic apparatus 21, the storage apparatus 22, the communication apparatus 23, the input apparatus 24, and the output apparatus 25 may be connected through a data bus 26.

The arithmetic apparatus 21 includes at least one of a CPU (Central Processing Unit), a GPU (Graphics Processing Unit), a FPGA (Field Programmable Gate Array), a DSP (Demand-Side Platform), and an ASIC (Application Specific Integrated Circuit), for example. The arithmetic apparatus 21 reads a computer program. For example, the arithmetic apparatus 21 may read a computer program stored in the storage apparatus 22. For example, the arithmetic apparatus 21 may read a computer program stored by a computer-readable and non-transitory recording medium, by using a not-illustrated recording medium reading apparatus provided in the information processing apparatus 2. The arithmetic apparatus 21 may acquire (i.e., download or read) a computer program from a not-illustrated apparatus disposed outside the information processing apparatus 2, through the communication apparatus 23 (or another communication apparatus). The arithmetic apparatus 21 executes the read computer program. Consequently, a logical functional block for performing an operation to be performed by the information processing apparatus 2 (e.g., the authentication operation described above, and especially, the authentication operation including the in-focus determination operation) is realized or implemented in the arithmetic apparatus 21. That is, the arithmetic apparatus 21 is allowed to function as a controller for realizing or implementing the logical functional block for performing an operation (in other words, processing) to be performed by the information processing apparatus 2.

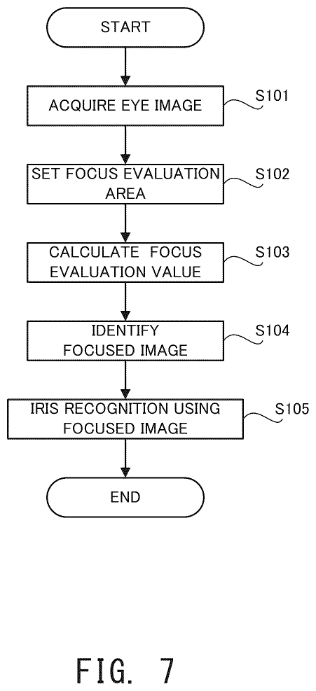

FIG. 6 illustrates an example of the logical functional block realized or implemented in the arithmetic apparatus 21 to perform the authentication operation (especially, the authentication operation including the in-focus determination operation). As illustrated in FIG. 6, an area setting unit 211 that is a specific example of the “setting unit” described later in Supplementary Note, an in-focus determination unit 212 that is a specific example of the “determination unit” described later in Supplementary Note, and an iris recognition unit 213 that is a specific example of the “authentication unit” described later in Supplementary Note, are realized or implemented in the arithmetic apparatus 21. The operation of each of the area setting unit 211, the in-focus determination unit 212, and the iris recognition unit 213 will be described in detail later with reference to FIG. 7 and the like, and thus, a description thereof is omitted here.

The storage apparatus 22 is configured to store desired data. For example, the storage apparatus 22 may temporarily store a computer program to be executed by the arithmetic apparatus 21. The storage apparatus 22 may temporarily store data that are temporarily used by the arithmetic apparatus 21 when the arithmetic apparatus 21 executes the computer program. The storage apparatus 22 may store data that are stored by the information processing apparatus 2 for a long time. The storage apparatus 22 may include at least one of a RAM (Random Access Memory), a ROM (Read Only Memory), a hard disk apparatus, a magneto-optical disk apparatus, a SSD (Solid State Drive), and a disk array apparatus. That is, the storage apparatus 22 may include a non-transitory recording medium.

The communication apparatus 23 is configured to communicate with the imaging apparatus 1 through a not-illustrated communication network. In the third example embodiment, the communication apparatus 23 receives (i.e., acquires) the person image IMG (specifically, the eye image IMG_E) from the imaging apparatus 1.

The input apparatus 24 is an apparatus that receives an input of information to the information processing apparatus 2 from an outside of the information processing apparatus 2. For example, the input apparatus 24 may include an operating apparatus (e.g., at least one of a keyboard, a mouse, and a touch panel) that is operable by an operator of the information processing apparatus 2. For example, the input apparatus 24 may include a reading apparatus that is configured to read information recorded as data on a recording medium that can be externally attached to the information processing apparatus 2.

The output apparatus 25 is an apparatus that outputs information to the outside of the information processing apparatus 2. For example, the output apparatus 25 may output information as an image. That is, the output apparatus 25 may include a display apparatus (a so-called display) that is configured to display an image indicating the information that is desirably outputted. For example, the output apparatus 25 may output information as audio/sound. That is, the output apparatus 25 may include an audio apparatus (a so-called speaker) that is configured to output the audio/sound. For example, the output apparatus 25 may output information onto a paper surface. That is, the output apparatus 25 may include a print apparatus (a so-called printer) that is configured to print desired information on the paper surface.

### (3-3) Authentication Operation Performed by Information Processing Apparatus 2 in Third Example Embodiment

Next, with reference to FIG. 7, the authentication operation performed by the information processing apparatus 2 in the third example embodiment (especially, the authentication operation including the in-focus determination operation) will be described. FIG. 7 is a flowchart illustrating a flow of the authentication operation (especially, the authentication operation including the in-focus determination operation) performed by the information processing apparatus 2 according to the third example embodiment.

As illustrated in FIG. 7, the information processing apparatus 2 acquires the eye image IMG_E from the imaging apparatus 1 (step S101). Therefore, the imaging apparatus 1 images the target person P in at least a part of a period in which the information processing apparatus 2 performs the authentication operation. In this situation, the information processing apparatus 2 may start the authentication operation, triggered by the imaging apparatus 1 imaging the target person P (i.e., triggered by the imaging apparatus 1 transmitting the eye image IMG_E to the information processing apparatus 2).

The imaging apparatus 1 may image the target person P at a predetermined imaging rate. That is, the imaging apparatus 1 may continuously image the target person P. For example, the imaging apparatus 1 may image the target person P at an imaging rate of imaging the target person P tens to hundreds of times per second. That is, the imaging apparatus 1 may image the target person P at an imaging rate of generating tens to hundreds of eye images IMG_E per second. In this instance, the imaging apparatus 1 may generate a plurality of eye images IMGs_E as time series data. The information processing apparatus 2 may acquire the plurality of eye images IMG_E as the time series data. The following describes an example in which the information processing apparatus 2 acquires the plurality of eye images IMG_E as the time series data.

The imaging apparatus 1 may image the target person P in at least a part of a period in which a positional relation changes between a focal plane FP of the imaging apparatus 1 and the target person P. The focal plane FP of the imaging apparatus 1 may mean an optical surface that intersects (typically, is perpendicular to) an optical axis of an optical system (e.g., a lens) of the imaging apparatus 1, and an optical surface on which the imaging apparatus 1 is focused. The focal plane FP of the imaging apparatus 1 may mean an optical surface that intersects (typically, is perpendicular to) an optical axis of an optical system (e.g., a lens) of the imaging apparatus 1, and an optical surface included in a range of the depth of focus of the optical system of the imaging apparatus 1.

As an example, as illustrated in FIG. 8A, when the target person P moves to the imaging apparatus 1, the positional relation changes between the focal plane FP and the target person P. Especially, when the target person P moves to the imaging apparatus 1 along the optical axis of the imaging apparatus 1 (e.g., an axis extending in a Y axis direction in FIG. 8A), the positional relation changes between the focal plane FP and the target person P. Therefore, the imaging apparatus 1 may image the target person P in at least a part of a period in which the target person P moves to the imaging apparatus 1. When the target person P moves to the imaging apparatus 1, a relative positional relation changes between the imaging apparatus 1 and the target person P. Specifically, when the target person P moves to the imaging apparatus 1 along the optical axis of the imaging apparatus 1, the relative positional relation changes between the imaging apparatus 1 and the target person Pin a direction along the optical axis of the imaging apparatus 1. Therefore, the imaging apparatus 1 may be considered to image the target person P in at least a part of a period in which the relative positional relation changes between the imaging apparatus 1 and the target person P.

As another example, as illustrated in FIG. 8B, when the imaging apparatus 1 moves to the target person P, the positional relation changes between the focal plane FP and the target person P. Especially, when the imaging apparatus 1 moves to the target person P along the optical axis of the imaging apparatus 1 (e.g., an axis extending in aY axis direction in FIG. 8B), the positional relation changes between the focal plane and the target person P. Therefore, the imaging apparatus 1 may image the target person P in at least a part of a period in which the imaging apparatus 1 moves to the target person P. When the imaging apparatus 1 moves to the target person P, the relative positional relation changes between the imaging apparatus 1 and the target person P. Specifically, when the imaging apparatus 1 moves to the target person P along the optical axis of the imaging apparatus 1, the relative positional relation changes between the imaging apparatus 1 and the target person P in the direction along the optical axis of the imaging apparatus 1. Therefore, the imaging apparatus 1 may be considered to image the target person P in at least a part of the period in which the relative positional relation changes between the imaging apparatus 1 and the target person P.

As another example, in a case where a focal length of the imaging apparatus 1 (specifically, a focal length of the optical system of the imaging apparatus 1) is variable, as illustrated in FIG. 8 C, when the focal length of the imaging apparatus 1 changes, the focal plane FP moves to the target person P. Especially, the focal plane FP to the target person P is moved along the optical axis of the imaging apparatus 1 (e.g., an axis extending in aY axis direction in FIG. 8C). Therefore, the positional relation changes between the focal plane FP and the target person P. Therefore, the imaging apparatus 1 may image the target person P in at least a part of a period in which the focal length of the imaging apparatus 1 changes. An example of the imaging apparatus 1 having a variable focal length may be an imaging apparatus including at least one of a zoom lens and a variable focus lens, as at least a part of the optical system.

Referring back to FIG. 7, the area setting unit 211 sets a focus evaluation area FA in the eye image IMG_E acquired in the step S101 (step S102). The focus evaluation area FA is an area used to evaluate the focus degree of the iris area IA. As described above, since the focus eye image IMG_E in which the iris area IA is in focus, is determined to be a focused image, the focus evaluation area FA may be regarded as an area used to determine whether or not the eye image IMG_E is a focused image.

An example of the focus evaluation area FA is illustrated in FIG. 9. As illustrated in FIG. 9, the area setting unit 211 may set the focus evaluation area FA such that at least a part of the focus evaluation area FA is included in the iris area IA. That is, the area setting unit 211 may set the focus evaluation area FA such that the focus evaluation area FA includes at least a part of the iris area IA. In a case where the focus evaluation area FA includes at least a part of the iris area IA, the information processing apparatus 2 is capable of properly determining whether or not the eye image IMG_E is a focused image by using the focus evaluation area FA.

The area setting unit 211 may set the focus evaluation area FA such that the focus evaluation area FA includes both at least a part of the iris area IA and an area different from the iris area IA. Even in this situation, as long as the focus evaluation area FA includes at least a part of the iris area IA, the information processing apparatus 2 is capable of properly determining whether or not the eye image IMG_E is a focused image by using the focus evaluation area FA. In this case, however, it is preferable that a ratio of the iris area IA in the focus evaluation area FA is greater than a ratio of the area that is different from the iris area IA in the focus evaluation area FA. In this case, as compared with a case where the ratio of the iris area IA in the focus evaluation area FA is less than the ratio of the area that is different from the iris area IA in the focus evaluation area FA, the information processing apparatus 2 is capable of properly determining whether or not the eye image IMG_E is a focused image by using the focus evaluation area FA.

Alternatively, as described later in a fourth example embodiment, the area setting unit 211 may set the focus evaluation area FA such that the focus evaluation area FA includes at least a part of the iris area IA, but does not include the area that is different from the iris area IA. In this instance, the information processing apparatus 2 is capable of more properly determining whether or not the eye image IMG_E is a focused image by using the focus evaluation area FA.

A size of the focus evaluation area FA may be arbitrary. In a case where the focus evaluation area FA is too large in size, a calculation cost required for the in-focus determination operation of determining whether or not the eye image IMG_E is a focused image by using the focus evaluation area FA, may be too high. On the other hand, in a case where the focus evaluation area FA is too small in size, the accuracy of the in-focus determination operation may be too low. Therefore, the area setting unit 211 may set the focus evaluation area FA having a size capable of achieving both a reduction in the calculation cost required for the in-focus determination operation and an improvement in the accuracy of the in-focus determination operation. That is, the area setting unit 211 may set the focus evaluation area FA having a size that may realize a condition in which the calculation cost required for the in-focus determination operation is appropriate and the accuracy of the in-focus determination operation is appropriate.

A shape of the focus evaluation area FA may be arbitrary. For example, the focus evaluation area FA may be rectangular in shape. In this case, as compared with a case where the shape of the focus evaluation area FA is a complicated shape that is different from a rectangular shape, the calculation cost required to calculate a focus evaluation value described later is low. This is because processing on a rectangular image is simpler than processing on an image of a complicated shape that is different from a rectangular shape. The shape of the focus evaluation area FA, however, may be a shape that is different from a rectangular shape. For example, the focus evaluation area FA may be polygonal in shape. For example, the focus evaluation area FA may be circular or elliptical in shape. For example, the focus evaluation area FA may be annular in shape. In a case where the focus evaluation area FA is annular in shape, the shape of the focus evaluation area FA may be the same as the shape of the iris area IA. In a case where the shape of the focus evaluation area FA is the same as the shape of the iris area IA, the focus evaluation area FA may include the entire iris area IA. That is, the focus evaluation area FA may coincide with the iris area IA.

The iris area IA may be an annular area surrounded by an inner iris contour (i.e., a pupil contour) and an outer iris contour. Preferably, the iris area IA may be an area obtained by removing an area where the iris is hidden by an eyelid, from the annular area surrounded by the inner iris contour (i.e., the pupil contour) and the outer iris contour.

As described above, in the step S101, the information processing apparatus 2 acquires the plurality of eye images IMG_E as the time series data. In this case, the area setting unit 211 sets the focus evaluation area FA for each of the plurality of eye images IMG_E. For example, the area setting unit 211 may set the focus evaluation area FA at the same position of each of the plurality of eye images IMG_E. That is, the area setting unit 211 may set the focus evaluation area FA at a first coordinate position in a first eye image IMG_E, may set the focus evaluation area FA at a second coordinate position that is the same as the first coordinate position in a second eye image IMG_E, . . . , and may set the focus evaluation area FA at an Nth coordinate position that is the same as the first to (N−1)th coordinate positions in an Nth eye image IMG_E (where N is a variable indicating a total number of the eye images IMG_E acquired in the step S101). Alternatively, for example, the area setting unit 211 may set the focus evaluation area FA at at least two different positions of the plurality of eye images IMG_E. As an example, the area setting unit 211 may set the focus evaluation area FA at the first coordinate position in the first eye image IMG_E, and may set the focus evaluation area FA at the second coordinate position that is different from the first coordinate position in the second eye image IMG_E.

Referring back to FIG. 7, after that, the in-focus determination unit 212 calculates a focus evaluation value of the eye image IMG_E by using the focus evaluation area FA set in the step S102 (step S103). The focus evaluation value is an evaluation parameter used to evaluate the focus degree of the iris area IA included in the eye image IMG_E. As described above, since the eye image IMG_E in which the iris area IA is in focus, is determined to be a focused image, the focus evaluation value may be regarded as an evaluation parameter used to determine whether or not the eye image IMG_E is a focused image.

The focus evaluation value may be any evaluation parameter as long as the focus degree of the iris area IA can be evaluated. For example, the focus evaluation value may be an evaluation parameter based on pixel values of a plurality of pixels included in the focus evaluation area FA. An example of the pixel value is a luminance value.

The third example embodiment describes an example in which the variance of luminance values of the plurality of pixels included in the focus evaluation area FA is used as the focus evaluation value. Hereinafter described will be a reason why the variance of the luminance values of the plurality of pixels included in the focus evaluation area FA can be used to evaluate the focus degree of the iris area IA. In the following description, the “variance of the luminance values of the plurality of pixels included in the focus evaluation area FA” is referred to as a “focus evaluation value (variance)”. In a case where the eye image IMG_E is a focused image, the eye (especially, the iris) of the target person P is clearly captured in the eye image IMG_E. That is, the eye (especially, the iris) of the target person P is captured in the eye image IMG_E in a relatively high contrast condition. Therefore, the variation of the luminance values of the plurality of pixels included in the focus evaluation area FA is relatively large. As a result, the focus evaluation value (variance) is relatively large. On the other hand, in a case where the eye image IMG_E is not a focused image, the eye (especially, the iris) of the target person P is blurred or out of focus in the eye image IMG_E. That is, the eye (especially, the iris) of the target person P is captured in the eye image IMG_E in a relatively low contrast condition. Therefore, the variation of the luminance values of the plurality of pixels included in the focus evaluation area FA is relatively small. As a result, the focus evaluation value (variance) is relatively small. Therefore, the focus evaluation value (variance) of the eye image IMG_E that is a focused image, is greater than the focus evaluation value (variance) of the eye image IMG_E that is not a focused image. Therefore, the focus evaluation value (variance) may be used as an evaluation parameter capable of determining whether of not the eye image IMG_E is a focused image.

As described above, in the step S101, the information processing apparatus 2 acquires the plurality of eye images IMG_E as the time series data. In this instance, the in-focus determination unit 212 calculates the focus evaluation value (variance) of each of the plurality of eye images IMG_E. That is, the in-focus determination unit 212 may calculate the focus evaluation value (variance) of the first eye image IMG_E by using the focus evaluation area FA set in the first eye image IMG_E, may calculate the focus evaluation value (variance) of the second eye image IMG_E by using the focus evaluation area FA set in the second eye image IMG_E, . . . , and may calculate the focus evaluation value (variance) of the Nth eye image IMG_E by using the focus evaluation area FA set in the Nth eye image IMG_E.

Thereafter, the in-focus determination unit 212 determines whether or not the eye image IMG_E acquired in the step S101 is a focused image, on the basis of the focus evaluation value (variance) calculated in the step S103 (step S104). As described above, in the step S101, the information processing apparatus 2 acquires the plurality of eye images IMG_E as the time series data. Therefore, in the step S104, the in-focus determination unit 212 identifies at least one eye image IMG_E that is a focused image, from the plurality of eye images IMG_E acquired in the step S101.

The in-focus determination unit 212 may determine that the eye image IMG_E in which the focus evaluation value (variance) satisfies a predetermined in-focus determination condition, is a focused image. The in-focus determination unit 212 may determine that the eye image IMG_E in which the focus evaluation value (variance) does not satisfy the predetermined in-focus determination condition, is not a focused image.

As an example, as described above, in a case where the eye image IMG_E is a focused image, the in-focus determination value (variance) is relatively large. Therefore, the in-focus determination unit 212 may use a first in-focus determination condition in which the focus evaluation value (variance) is greater than a predetermined threshold TH, as illustrated in FIG. 10A that is a graph illustrating the focus evaluation value (variance) of the plurality of eye images IMG_E, as the predetermined in-focus determination condition. In this instance, the in-focus determination unit 212 may determine that the eye image IMG_E in which the focus evaluation value (variance) is greater than the predetermined threshold TH, is a focused image. The in-focus determination unit 212 may determine that the eye image IMG_E in which the focus evaluation value (variance) is less than the predetermined threshold TH, is not a focused image. The in-focus determination unit 212 may identify, as the focused image, at least one eye image IMG_E in which the focus evaluation value (variance) is greater than the predetermined threshold TH, from the plurality of eye images IMG_E acquired in the step S101.

The predetermined threshold TH used in the first in-focus determination condition may be set as an appropriate value that allows distinction of the eye image IMG_E that can be regarded as a focused image and the eye image IMG_E that cannot be regarded as a focused image, from the focus evaluation value (variance). The predetermined threshold TH may be set as a value obtained by multiplying a maximal value of the focus evaluation values (variance) of the plurality of eye images IMG_E acquired in the step S101, by a predetermined coefficient that is greater than 0 and less than 1. The predetermined threshold TH may be a fixed value. The predetermined threshold TH may be variable. The predetermined threshold TH may be set by a user of the information processing apparatus 2.

The in-focus determination unit 212 may change the predetermined threshold TH on the basis of the number of the eye images IMG_E identified as the focused image. For example, in a case where the number of the eye images IMG_E identified as the focused image exceeds a predetermined upper limit number, the in-focus determination unit 212 may change the predetermined threshold TH such that the predetermined threshold TH becomes larger. As a consequence, the number of the eye images IMG_Es identified as the focused image is reduced, as compared with the number before the predetermined threshold TH is changed, and thus, the number of the eye images IMG_Es identified as the focused image is expected to be less than the predetermined upper limit (i.e., to be an appropriate number).

As another example, the in-focus determination unit 212 may use a second in-focus determination condition in which the focus evaluation value (variance) is maximal, as illustrated in FIG. 10B that is a graph illustrating the focus evaluation value (variance) of the plurality of eye images IMG_E, as the predetermined in-focus determination condition. In this instance, the in-focus determination unit 212 may determine that the eye image IMG_E in which the focus evaluation value (variance) is maximal, is a focused image. The in-focus determination unit 212 may determine that the eye image IMG_E in which the focus evaluation value (variance) is not maximal, is not a focused image. The in-focus determination unit 212 may identify, as the focused image, one eye image IMG_E in which the focus evaluation value (variance) is maximal, from the plurality of eye images IMG_E acquired in the step S101.

The operation including the step S102 to the step S104 described above corresponds to the in-focus determination operation that is a part of the authentication operation.

Referring back to FIG. 7, after that, the iris recognition unit 213 authenticates the target person P by using the eye image IMG_E that is determined to be a focused image in the step S104 (step S105).

When each of the plurality of eye images IMG_E is determined to be a focused image in the step S104, the iris recognition unit 213 may authenticate the target person P by using at least one of the plurality of eye images IMG_E, each of which is determined to be a focused image. For example, the iris recognition unit 213 may select one eye image IMG_E from the plurality of eye images IMG_E, each of which is determined to be a focused image, randomly or on the basis of a predetermined selection criterion. The iris recognition unit 213 may then authenticate the target person P by using the selected one eye image IMG_E. For example, the iris recognition unit 213 may select at least two eye images IMG_E from the plurality of eye images IMG_E, each of which is determined to be a focused image, randomly or on the basis of a predetermined selection criterion. The iris recognition unit 213 may then authenticate the target person P by using the selected at least two eye images IMG_E. As an example, the iris recognition unit 213 may determine that the authentication of the target person P is successful in a case where at least one of at least two authentications using the selected at least two eye images IMG_E is successful. As another example, the iris recognition unit 213 may determine that the authentication of the target person P is successful in a case where at least two authentications using the selected at least two eye images IMG_E are all successful.

### (3-4) Technical Effect of Authentication System SYS in Third Example Embodiment

As described above, the information processing apparatus 2 according to the third example embodiment determines whether or not the eye image IMG_E is a focused image by using the focus evaluation value (variance). Therefore, the information processing apparatus 2 is capable of determining whether or not the eye image IMG_E is a focused image with higher accuracy than that in a case where it is determined whether or not the eye image IMG_E is a focused image by using a focus evaluation value that is different from the focus evaluation value (variance). This is because, as described above, the focus evaluation value (variance) of the eye image IMG_E that is a focused image is greater than the focus evaluation value (variance) of the eye image IMG_E that is not a focused image. Therefore, the information processing apparatus 2 is capable of solving a technical problem of a reduction in the accuracy of determining whether or not the eye image IMG_E is a focused image.

In addition, in a case where it is determined whether or not the eye image IMG_E is a focused image by using the focus evaluation value (variance), even if the focus evaluation area FA is reasonably small in size, the information processing apparatus 2 is capable of determining whether or not the eye image IMG_E is a focused image with high accuracy. This is because even if the focus evaluation area FA is smaller in size, there is no difference in the fact that the focus evaluation value (variance) of the eye image IMG_E that is a focused image, is not greater than the focus evaluation value (variance) of the eye image IMG_E that is not a focused image.

As the focus evaluation area FA becomes smaller in size, the calculation cost required to calculate the focus evaluation (variance) is reduced. Therefore, the information processing apparatus 2 is capable of determining whether or not the eye image IMG_E is a focused image at a lower calculation cost than that in a case where it is determined whether or not the eye image IMG_E is a focused image by using a focus evaluation value different from the focus evaluation value (variance). Therefore, the information processing apparatus 2 is capable of solving a technical problem of a high calculation cost required to determine whether or not the eye image IMG_E is a focused image.

In addition, as the focus evaluation area FA becomes smaller in size, a time required to calculate the focus evaluation (variance) is reduced. Therefore, the information processing apparatus 2 is capable of determining whether or not the eye image IMG_E is a focused image at a higher speed than that in a case where it is determined whether or not the eye image IMG_E is a focused image by using a focus evaluation value that is different from the focus evaluation value (variance). Therefore, the information processing apparatus 2 is capable of solving a technical problem that it takes a longer time required to determine whether or not the eye image IMG_E is in the focused image.

In the third example embodiment, the information processing apparatus 2 may use the first in-focus determination condition in which the focus evaluation value (variance) is greater than the predetermined threshold TH, as the in-focus determination condition for determining whether or not the eye image IMG_E is a focused image. In this situation, the information processing apparatus 2 is capable of properly determining whether or not the eye image IMG_E is a focused image.

Furthermore, in the third example embodiment, the information processing apparatus 2 may use the second in-focus determination condition in which the focus evaluation value (variance) is maximal, as the in-focus determination condition for determining whether or not the eye image IMG_E is a focused image. In this situation, the information processing apparatus 2 is capable of properly determining whether or not the eye image IMG_E is a focused image. Especially, the information processing apparatus 2 is capable of narrowing down one eye image IMG_E that is likely to be a focused image, from the plurality of eye images IMG_E.

Furthermore, in the third example embodiment, the imaging apparatus 1 may image the target person P in at least a part of the period in which the positional relation changes between the focal plane FP of the imaging apparatus 1 and the target person P. In this instance, the imaging apparatus 1 may generate a plurality of eye images IMG_E having different focus evaluations (variances). Therefore, the information processing apparatus 2 is capable of properly acquiring at least one eye image IMG_E corresponding to the focused image, from the plurality of eye images IMG_E having different focus evaluation values (variances).

Furthermore, in the third example embodiment, the period in which the relative positional relation changes between the imaging apparatus 1 and the target person P, may be used as the period in which the positional relation changes between the focal plane FP of the imaging apparatus 1 and the target person P. In this case, when the imaging apparatus 1 moves, the positional relation changes between the focal plane FP of the imaging apparatus 1 and the target person P. Therefore, the imaging apparatus 1 is capable of relatively easily changing the positional relation between the focal plane FP of the imaging apparatus 1 and the target person P. Furthermore, when the target person P moves, the positional relation changes between the focal plane FP of the imaging apparatus 1 and the target person P. Therefore, the target person P is able to relatively easily change the positional relation between the focal plane FP of the imaging apparatus 1 and the target person P.

Furthermore, in the third example embodiment, the period in which the focal length of the imaging apparatus 1 changes may be used as the period in which the positional relation changes between the focal plane FP of the imaging apparatus 1 and the target person P. In this instance, at least one of the imaging apparatus 1 and the target person P may not necessarily move in order to change the positional relation between the focal plane FP of the imaging apparatus 1 and the target person P. Therefore, the imaging apparatus 1 is capable of relatively easily changing the positional relation between the focal plane FP of the imaging apparatus 1 and the target person P.

### (3-4) Modified Examples of Authentication System SYS in Third Example Embodiment

### (3-4-1) First Modified Example

In the above description, the focus evaluation value (variance) is the variance of the luminance values of the plurality of pixels included in the focus evaluation area FA. That is, the focus evaluation value (variance) is the variance of the luminance values of all the pixels included in the focus evaluation area FA. However, the variance of the luminance values of a plurality of pixels corresponding to a part of all the pixels included in the focus evaluation area FA may be used as the focus evaluation value (variance). In this case, the information processing apparatus 2 is capable of calculating the focus evaluation value (variance) at a lower calculation cost than that in a case where the variance of the luminance values of all the pixels included in the focus evaluation area FA is calculated as the focus evaluation value (variance). That is, the information processing apparatus 2 is capable of performing the in-focus determination operation at a lower calculation cost.

As an example, the information processing apparatus 2 may calculate the variance of the luminance values of a plurality of pixels corresponding to partial pixels that are selected randomly from all the pixels included in the focus evaluation area FA, as the focus evaluation value (variance). As another example, the information processing apparatus 2 may calculate the variance of the luminance values of a plurality of pixels corresponding to partial pixels that are selected, on the basis of a predetermined pixel selection criterion, from all the pixels included in the focus evaluation area FA, as the focus evaluation value (variance). For example, the information processing apparatus 2 may calculate the variance of the luminance values of a plurality of pixels included in an upper half area of the focus evaluation area FA, as the focus evaluation value (variance). For example, the information processing apparatus 2 may calculate the variance of the luminance values of a plurality of pixels included in a lower half area of the focus evaluation area FA, as the focus evaluation value (variance). For example, the information processing apparatus 2 may calculate the variance of the luminance values of a plurality of pixels that are selected on the basis of a pixel selection criterion of selecting one pixel for each pixel block including P pixels that are arranged along at least one of a row direction and a column direction in the focus evaluation area FA (where P is a variable indicating an integer of 2 or more), as the focus evaluation value (variance).

In the above description, in the step S102 in FIG. 7, the information processing apparatus 2 sets the focus evaluation area FA for each of the plurality of eye images IMG_E acquired in the step S101. That is, in the step S103 in FIG. 7, the information processing apparatus 2 calculates the focus evaluation value (variance) of each of the plurality of eye images IMG_E acquired in the step S101. In the step S102 in FIG. 7, however, the information processing apparatus 2 may set the focus evaluation area FA for a part of the plurality of eye images IMG_E acquired in the step S101, but may not set the focus evaluation area FA for a remaining part of the plurality of eye images IMG_E acquired in the step S101. That is, in the step S102 in FIG. 7, the information processing apparatus 2 may calculate the focus evaluation value (variance) of a part of the plurality of eye images IMG_E acquired in the step S101, but may not calculate the focus evaluation value (variance) of a remaining part of the plurality of eye images IMG_E acquired in the step S101. The information processing apparatus 2 may calculate the focus evaluation value (variance) of one eye image IMG_E, but may not calculate the focus evaluation value (variance) of another eye image IMG_E. In this case, the information processing apparatus 2 is capable of calculating the focus evaluation value (variance) at a lower calculation cost than that in a case where the focus evaluation area FA is set for all of the plurality of eye images IMG_E and where all the focus evaluation values (variance) of the plurality of eye images IMG_E are calculated. That is, the information processing apparatus 2 is capable of performing the in-focus determination operation at a lower calculation cost.

As an example, the information processing apparatus 2 may set the focus evaluation area FA for partial eye images IMG_E that are randomly selected from the plurality of eye images IMG_E, but may not set the focus evaluation area FA for the remaining eye images IMG_E that are not selected. As another example, the information processing apparatus 2 may set the focus evaluation area FA for partial eye images IMG_E that are selected from the plurality of eye images IMG_E on the basis of a predetermined image selection criterion, but may not set the focus evaluation area FA for the remaining eye images IMG_E that are not selected. For example, in a case where a degree of similarity between one eye image IMG_E and another eye image IMG_E is greater than or equal to a predetermined value, the information processing apparatus 2 may set the focus evaluation area FA for the one eye image IMG_E, but may not set the focus evaluation area FA for the other eye image IMG_E. For example, the information processing apparatus 2 may set the focus evaluation area FA for the eye image IMG_E that is selected on the basis of an image selection criterion of selecting one eye image IMG_E for each image block including Q eye images IMG_E that are consecutive in a time-series manner (where Q is a variable indicating an integer number of 2 or more), but may not set the focus evaluation area FA for the remaining eye images IMG_E that are not selected.

### (3-4-2) Second Modified Example

In the above description, the variance of the luminance values of the plurality of pixels included in the focus evaluation area FA is used as the focus evaluation value. As the focus evaluation value, however, an evaluation parameter that is different from the variance of the luminance values of the plurality of pixels included in the focus evaluation area FA may be used.

As an example, a contrast of the focus evaluation area FA (i.e., a ratio between a maximum value of the luminance values and a minimum value of the luminance values) may be used as the focus evaluation value. The contrast of the focus evaluation area FA when the eye image IMG_E is a focused image is higher than the contrast of the focus evaluation area FA when the eye image IMG_E is not a focused image. Therefore, the contrast of the focus evaluation area FA may be used as an evaluation parameter that allows the determination of whether or not the eye image IMG_E is a focused image.

As another example, an evaluation parameter regarding an edge detected by extracting a high-frequency component from spatial frequency components included in the focus evaluation area FA may be used as the focus evaluation value. A width of the edge when the eye image IMG_E is a focused image is narrower than that of the edge when the eye image IMG_E is not a focused image. Alternatively, when the eye image IMG_E is not a focused image, the edge may not be detected. Therefore, the evaluation parameter regarding the edge may be used as the evaluation parameter that allows the determination of whether or not the eye image IMG_E is a focused image.

### (3-4-3) Third Modified Example

In the above description, the information processing apparatus 2 includes the iris recognition unit 213. The information processing apparatus 2, however, may not include the iris recognition unit 213. That is, the information processing apparatus 2 may not authenticate the target person P. In such a case, the information processing apparatus 2 may transmit (in other words, output) the eye image IMG_E that is determined to be a focused image, to another information processing apparatus for authenticating the target person P (or any target). The other information processing apparatus may receive (in other words, acquire) the eye image IMG_E transmitted from the information processing apparatus 2, and may authenticate the target person P (or any target) by using the received eye image IMG_E.

### (3-4-4) Fourth Modified Example

In the above description, the imaging apparatus 1 images the eye of the target person P, thereby generating the eye image IMG_E in which the eye of the target person P is captured as the body of the target person P, as the person image IMG. In the fourth modified example, the imaging apparatus 1 may image the face of the target person P, thereby generating a face image in which the face of the target person P is captured as the body of the target person P, as the person image IMG, in addition to or instead of the eye image IMG_E. In such a case, the information processing apparatus 2 may perform an authentication operation regarding the face recognition. Specifically, the information processing apparatus 2 may identify a face area including the face of the target person P from the face image. The information processing apparatus 2 may extract a feature of the face from the identified face area. The information processing apparatus 2 may authenticate the target person P on the basis of the extracted feature of the face.

Furthermore, the information processing apparatus 2 may perform a in-focus determination operation of determining whether or not the face image is a focused image in which the face area is in focus. Even in this instance, the information processing apparatus 2 may perform the same operation as the in-focus determination operation illustrated in FIG. 7. For example, the information processing apparatus 2 may set the focus evaluation area FA in the face image (the step S102 in FIG. 7). The focus evaluation area FA set in the face image is an area used to determine whether or not the face image is a focused image. The information processing apparatus 2 may set the focus evaluation area FA such that at least a part of the focus evaluation area FA is included in the face area. Thereafter, the information processing apparatus 2 may calculate a focus evaluation value of the face image by using the focus evaluation area FA (the step S103 in FIG. 7). The focus evaluation value of the face image is an evaluation parameter used to determine whether or not the face image is a focused image. As the focus evaluation value of the face image, as in the focus evaluation value of the eye image IMG_E, the variance of the luminance values of the plurality of pixels included in the focus evaluation area FA may be used. Thereafter, the information processing apparatus 2 may determine whether or not the face image is a focused image on the basis of the focus evaluation value (variance) (the step S104 in FIG. 7). In this case, as in a case where it is determined whether or not the eye image IMG_E is a focused image, the information processing apparatus 2 may determine that the face image in which the focus evaluation value (variance) satisfies the above-described predetermined in-focus determination condition, is a focused image. The information processing apparatus 2 may authenticate the target person P by using the face image that is determined to be a focused image by the in-focus determination operation.

The information processing apparatus 2 may authenticate the target person P by using both the eye image IMG_E and the face image. That is, the information processing apparatus 2 may perform multi-modal authentication. In this instance, the information processing apparatus 2 may separately perform a first in-focus determination operation of determining whether or not the eye image IMG_E is a focused image and a second in-focus determination operation of determining whether or not the face image is a focused image. In this instance, the information processing apparatus 2 may perform the iris recognition on the target person P by using the eye image IMG_E that is determined to be a focused image by the first in-focus determination operation, and may perform the face recognition on the target person P by using the face image that is determined to be a focused image by the second in-focus determination operation. Alternatively, the information processing apparatus 2 may perform the second face image operation of determining whether or not the face image is a focused image, but may not perform the first in-focus determination operation of determining whether or not the eye image IMG_E is a focused image. In this instance, the information processing apparatus 2 may perform the face recognition on the target person P by using the face image that is determined to be a focused image by the second in-focus determination operation. Furthermore, the information processing apparatus 2 may extract the eye image IMG_E from the face image that is determined to be a focused image by the second in-focus determination operation, and may perform the iris recognition on the target person P by using the extracted eye image IMG_E.

### (4) Fourth Example Embodiment

Next, a fourth example embodiment of an information processing apparatus, an information processing method, and a recording medium will be described. The following describes the fourth example embodiment of the information processing apparatus, the information processing method, and the recording medium, by using an authentication system SYSb to which the fourth example embodiment of the information processing apparatus, the information processing method, and the recording medium is applied.

The authentication system SYSb in the fourth example embodiment is different from the authentication system SYS in the third example embodiment, in the method of setting the focus evaluation area FA by the information processing apparatus 2 (the in-focus determination unit 212). Other features of the authentication system SYSb in the fourth example embodiment may be the same as those of the authentication system SYS in the third example embodiment. Therefore, hereinafter, the focus evaluation area FA set by the information processing apparatus 2 (the in-focus determination unit 212) according to the fourth example embodiment will be described with reference to FIG. 11A to FIG. 11D. Each of FIG. 11A to FIG. 11D illustrates the focus evaluation area FA set by the information processing apparatus 2 (the in-focus determination unit 212) according to the fourth example embodiment.

FIG. 11A illustrates a first setting process of setting the focus evaluation area FA in the fourth example embodiment. As illustrated in FIG. 11A, the in-focus determination unit 212 may set the focus evaluation area FA in an area that is different from a pupil area PA including the pupil of the target person P. That is, the in-focus determination unit 212 may set the focus evaluation area FA such that the focus evaluation area FA does not include the pupil area PA. In other words, the in-focus determination unit 212 may set the focus evaluation area FA such that the focus evaluation area FA does not overlap the pupil area PA.

In this case, the information processing apparatus 2 calculates the focus evaluation value by using the focus evaluation area FA excluding the pupil area PA. That is, the information processing apparatus 2 determines whether or not the eye image IMG_E is a focused image by using the focus evaluation area FA excluding the pupil area PA. Therefore, the information processing apparatus 2 is capable of determining whether or not the eye image IMG_E is a focused image with higher accuracy than that in a case where it is determined whether or not the eye image IMG_E is a focused image by using the focus evaluation area FA including the pupil area PA. The pupil area PA is generally much darker than the iris area IA. Therefore, in a case where the focus evaluation area FA includes the pupil area PA, the focus evaluation value may vary unintentionally due to the fact that the focus evaluation area FA includes the pupil area PA that is much darker than the iris area IA. For example, the focus evaluation value that is set for the eye image IMG_E which is a focused image and that is calculated from the focus evaluation area FA including the pupil area PA, may be close to the focus evaluation value calculated from the focus evaluation area FA set for the eye image IMG_E that is not a focused image. As a consequence, the eye image IMG_E that is a focused image, may be erroneously determined not to be a focused image. For example, the focus evaluation value that is set for the eye image IMG_E which is not a focused image and that is calculated from the focus evaluation area FA including the pupil area PA, may be close to the focus evaluation value calculated from the focus evaluation area FA set for the eye image IMG_E that is a focused image. As a consequence, the eye image IMG_E that is not a focused image, may be erroneously determined to be a focused image. This may cause a technical problem of a reduction in the accuracy of determining whether or not the eye image IMG_E is a focused image. In a case where the focus evaluation area FA excluding the pupil area PA is set, however, there is not a technical problem of a reduction in the accuracy of determining whether or not the eye image IMG_E is a focused image due to the fact that the pupil area PA is included in the focus evaluation area FA. Therefore, the information processing apparatus 2 is capable of determining whether or not the eye image IMG_E is a focused image with high accuracy. That is, the information processing apparatus 2 is capable of solving a technical problem of a reduction in the accuracy of the in-focus determination operation.

FIG. 11B illustrates a second setting process of setting the focus evaluation area FA in the fourth example embodiment. As illustrated in FIG. 11B, the in-focus determination unit 212 may set the focus evaluation area FA in an area that is different from a reflection area RA including a reflected image of light entering the eye of the target person P. That is, the in-focus determination unit 212 may set the focus evaluation area FA such that the focus evaluation area FA does not include the reflection area RA. In other words, the in-focus determination unit 212 may set the focus evaluation area FA such that the focus evaluation area FA does not overlap with the reflection area RA. An example of the light entering the eye of the target person P is at least one of ambient light and illumination light described in a seventh example embodiment described later.

In this instance, the information processing apparatus 2 calculates the focus evaluation value by using the focus evaluation area FA excluding the reflection area RA. That is, the information processing apparatus 2 determines whether or not the eye image IMG_E is a focused image by using the focus evaluation area FA excluding the reflection area RA. Therefore, the information processing apparatus 2 is capable of determining whether or not the eye image IMG_E is a focused image with higher accuracy than that in a case where it is determined whether or not the eye image IMG_E is a focused image by using the focus evaluation area FA including the reflection area RA. The reflection area RA is generally much brighter than the iris area IA. Therefore, in a case where the focus evaluation area FA includes the reflection area RA, the focus evaluation may vary unintentionally due to the fact that the focus evaluation area FA includes the reflection area RA that is much brighter than the iris area IA. The reason is the same as the reason why the focus evaluation value varies unintentionally due to the fact that the focus evaluation area FA includes the pupil area PA. Consequently, there may be a technical problem of a reduction in the accuracy of determining whether or not the eye image IMG_E is a focused image. In a case where the focus evaluation area FA excluding the reflection area RA is set, however, there is not a technical problem of a reduction in the accuracy of determining whether or not the eye image IMG_E is a focused image due to the fact that the reflection area RA is included in the focus evaluation area FA. Therefore, the information processing apparatus 2 is capable of determining whether or not the eye image IMG_E is a focused image with high accuracy. That is, the information processing apparatus 2 is capable of solving the technical problem of a reduction in the accuracy of the in-focus determination operation.

The in-focus determination unit 212 may identify (i.e., detect) the reflection area RA on the basis of luminance values (e.g., a mean/average value thereof) of pixels included in a sclera area SA including a sclera (a so-called white of the eye) of the target person P. Specifically, the luminance values of the pixels included in the sclera area SA are generally higher than the luminance values of the pixels included in the iris area IA. Therefore, in a case where the iris area IA includes an area in which the luminance values are the same as or higher than those of the pixels included in the sclera area SA, it is likely that the area is not the iris area IA (e.g., is the reflection area RA). Therefore, in a case where there is a certain size of area on the iris area IA in which the luminance values are the same as or higher than those of the pixels included in the sclera area SA, the in-focus determination unit 212 may identify the area as the reflection area RA. Consequently, the in-focus determination unit 212 is capable or properly identifying the reflection area RA.

FIG. 11C illustrates a third setting process of setting the focus evaluation area FA in the fourth example embodiment. As illustrated in FIG. 11C, the in-focus determination unit 212 may set the focus evaluation area FA in an area that is different from an eyelash area LA including eyelashes of the target person P. That is, the in-focus determination unit 212 may set the focus evaluation area FA such that the focus evaluation area FA does not include the eyelash area LA. In other words, the in-focus determination unit 212 may set the focus evaluation area FA such that the focus evaluation area FA does not overlap the eyelash area LA.

In this case, the information processing apparatus 2 calculates the focus evaluation value by using the focus evaluation area FA excluding the eyelash area LA. That is, the information processing apparatus 2 determines whether or not the eye image IMG_E is a focused image by using the focus evaluation area FA excluding the eyelash area LA. Therefore, the information processing apparatus 2 is capable of determining whether or not the eye image IMG_E is a focused image with higher accuracy than that in a case where it is determined whether or not the eye image IMG_E is a focused image by using the focus evaluation area FA including the eyelash area LA. The eyelash area LA is generally much darker than the iris area IA. Therefore, in a case where the focus evaluation area FA includes the eyelash area LA, the focus evaluation value may vary unintentionally due to the fact that the focus evaluation area FA includes the eyelash area LA that is much darker than the iris area IA. The reason is the same as the reason why the focus evaluation value varies unintentionally due to the fact that the focus evaluation area FA includes the pupil area PA. Consequently, there may be a technical problem of a reduction in the accuracy of determining whether or not the eye image IMG_E is a focused image. In a case where the focus evaluation area FA excluding the eyelash area LA is set, however, there is not a technical problem of a reduction in the accuracy of determining whether or not the eye image IMG_E is a focused image due to the fact that the eyelash area LA is included in the focus evaluation area FA. Therefore, the information processing apparatus 2 is capable of determining whether or not the eye image IMG_E is a focused image with high accuracy. That is, the information processing apparatus 2 is capable of solving the technical problem of a reduction in the accuracy of the in-focus determination operation.

FIG. 11D illustrates a fourth setting process of setting the focus evaluation area FA in the fourth example embodiment. As illustrated in FIG. 11D, the in-focus determination unit 212 may set the focus evaluation area FA in a lower area DA corresponding to a lower half area of the iris area IA. The lower area DA may mean an area below a horizon line CL passing through a center of the iris area IA (i.e., a center of the pupil area PA).

The lower area DA is unlikely to include upper eyelashes of the target person P. Furthermore, since lower eyelashes of a human extend downward (or hang down), the lower area DA is unlikely to include the lower eyelashes of the target person P. Therefore, in a case where the focus evaluation area FA is set in the lower area DA of the iris area IA, it is more likely that the eyelash area LA described in FIG. 11C is not included in the focus evaluation area FA, as compared with a case where the focus evaluation area FA is set in an area that is different from the lower area DA of the iris area IA. Therefore, the information processing apparatus 2 is capable of determining whether or not the eye image IMG_E is a focused image with high accuracy.

The in-focus determination unit 212 may set the focus evaluation area FA by using at least two of the first setting method to the fourth setting method. For example, the in-focus determination unit 212 may set the focus evaluation area FA in an area that is different from both the pupil area PA and the reflection area RA by using the first and second setting methods. That is, the in-focus determination unit 212 may set the focus evaluation area FA excluding both the pupil area PA and the reflection area RA. The in-focus determination unit 212 may set the focus evaluation area FA that does not overlap both the pupil area PA and the reflection area RA. In a case where at least two of the first setting method to the fourth setting method are used to set the focus evaluation area FA, the information processing apparatus 2 is capable of determining whether or not the eye image IMG_E is a focused image with higher accuracy than that in a case where only one of the first setting method to the fourth setting method is used to set the focus evaluation area FA.

### (5) Fifth Example Embodiment

Next, a fifth example embodiment of an information processing apparatus, an information processing method, and a recording medium will be described. The following describes the fifth example embodiment of the information processing apparatus, the information processing method, and the recording medium, by using an authentication system SYSc to which the fifth example embodiment of the information processing apparatus, the information processing method, and the recording medium is applied.

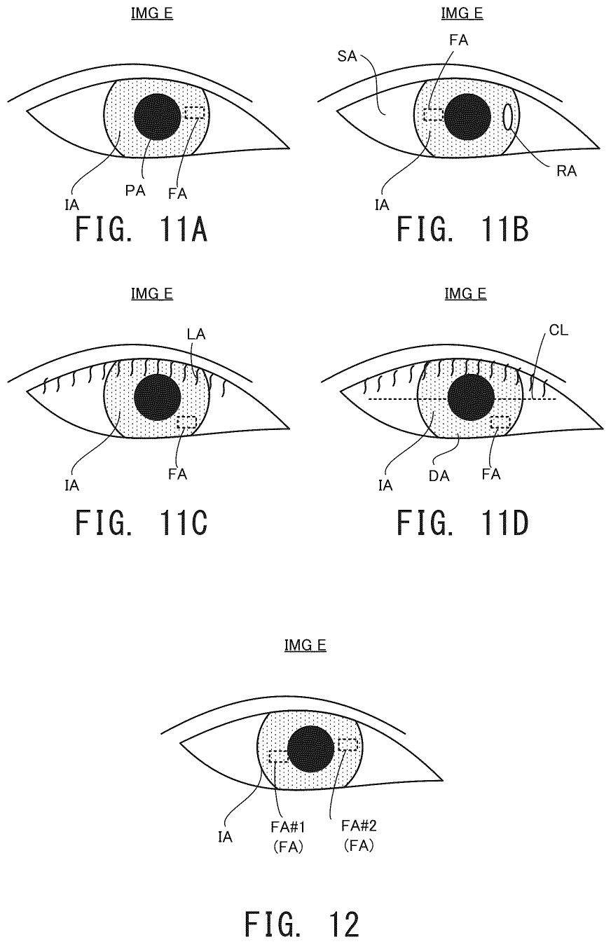

The authentication system SYSc in the fifth example embodiment is different from at least one of the systems from the authentication system SYS in the third example embodiment to the authentication system SYSb in the fourth example embodiment, in that the information processing apparatus 2 (the in-focus determination part 212) may set a plurality of focus evaluation areas FA. For example, FIG. 12 illustrates an example in which the in-focus determination unit 212 sets two focus evaluation areas FA (specifically, a first focus evaluation area FA #1 and a second focus evaluation area FA #2). Other features of the authentication system SYSc in the fifth example embodiment may be the same as those of at least one of the systems from the authentication system SYS in the third example embodiment to the authentication system SYSb in the fourth example embodiment.

In a case where the plurality of focus evaluation areas FA are set, the in-focus determination unit 212 may respectively calculate a plurality of focus evaluation values of the eye image IMG_E, by using the plurality of focus evaluation areas FA. In the example illustrated in FIG. 12, the in-focus determination unit 212 may calculate a first focus evaluation value of the eye image IMG_E by using the first focus evaluation area FA #1, and may calculate a second focus evaluation value of the eye image IMG_E by using the second focus evaluation area FA #2.

Thereafter, the in-focus determination unit 212 may determine whether or not the eye image IMG_E is a focused image on the basis of the plurality of focus evaluation values. For example, the in-focus determination unit 212 may determine that the eye image IMG_E is a focused image in a case where at least one focus evaluation value satisfies the above-described in-focus determination criterion. On the other hand, for example, the in-focus determination unit 212 may determine that the eye image IMG_E is not a focused image in a case where all of the plurality of focus evaluation values does not satisfy the in-focus determination criterion. Alternatively, for example, the in-focus determination unit 212 may determine that the eye image IMG_E is a focused image in a case where all of the plurality of the focus evaluation values satisfy the above-described in-focus determination condition. On the other hand, for example, the in-focus determination unit 212 may determine that the eye image IMG_E is not a focused image in a case where at least one focus evaluation value does not satisfy the in-focus determination criterion.

The in-focus determination unit 212 may determine whether or not the eye image IMG_E is a focused image on the basis of a statistic value of the plurality of focus evaluation values. An example of the statistic value is at least one of a simple average value, a weighted average value, a maximum value, a minimum value, a mean value, and a mode value. In this case, the in-focus determination unit 212 may determine that the eye image IMG_E is a focused image in a case where the statistic value of the plurality of the focus evaluation values satisfies the above-described in-focus determination condition. On the other hand, the in-focus determination unit 212 may determine that the eye image IMG_E is not a focused image in a case where the statistic value of the plurality of focus evaluation values does not satisfy the above-described in-focus determination criterion.

As described above, the information processing apparatus 2 according to the fifth example embodiment is capable of determining whether or not the eye image IMG_E is a focused image on the basis of the plurality of focus evaluation values. Therefore, the information processing apparatus 2 is capable of determining whether or not the eye image IMG_E is a focused image with higher accuracy.

### (6) Sixth Example Embodiment

Next, a sixth example embodiment of an information processing apparatus, an information processing method, and a recording medium will be described. The following describes the sixth example embodiment of the information processing apparatus, the information processing method, and the recording medium, by using an authentication system SYSd to which the sixth example embodiment of the information processing apparatus, the information processing method, and the recording medium is applied.

The authentication system SYSd in the sixth example embodiment is different from at least one of the systems from the authentication system SYS in the third example embodiment to the authentication system SYSc in the fifth example embodiment, in that the imaging apparatus 1 is configured to change an imaging range. Other features of the authentication system SYSd in the sixth example embodiment may be the same as those of at least one of the systems from the authentication system SYS in the third example embodiment to the authentication system SYSc in the fifth example embodiment.

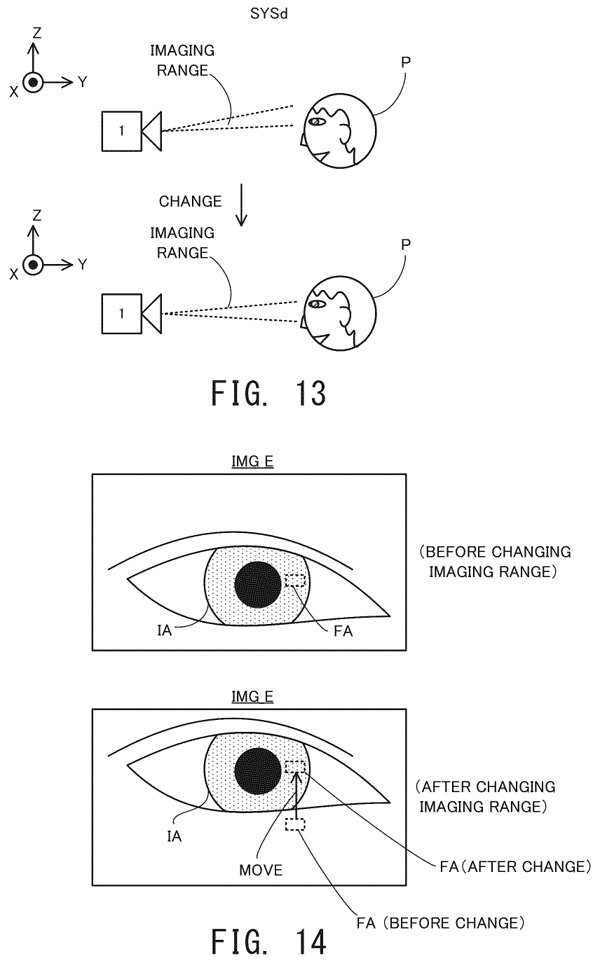

The imaging apparatus 1 may be configured to change the imaging range such that the imaging range is moved vertically, as illustrated in FIG. 13, for example. The imaging apparatus 1 may be configured to change the imaging range such that the imaging range is moved horizontally, in addition to or instead of the vertically, for example.

The imaging apparatus 1 may change the imaging range in at least a part of a period in which the target person P is imaged at a constant imaging rate. The imaging apparatus 1 may change the imaging range before imaging the target person P. The imaging apparatus 1 may change the imaging range after imaging the target person P.

The imaging apparatus 1 may change the imaging range by changing an orientation of the imaging apparatus 1. In this instance, the authentication system SYSd may include a drive apparatus (e.g., an actuator) that is configured to move the imaging apparatus 1 (typically, rotate it around a predetermined rotational axis) to change the orientation of the imaging apparatus 1. Alternatively, in a case where the imaging apparatus 1 includes a mirror that is configured to reflect light from the target person P toward an image sensor (e.g., a CCD (Charge Coupled Device) sensor or a CMOS (Complementary Metal Oxide Semiconductor) sensor), the imaging apparatus 1 may change the imaging range by moving the mirror (typically, rotating it around a predetermined rotational axis).

In addition, in a case where the imaging apparatus 1 is configured to change the imaging range, the information processing apparatus 2 (the area setting unit 211) may set the focus evaluation area FA in accordance with the change in the imaging range. Specifically, as described above, in a case where the imaging range is changed in at least a part of a period in which the imaging apparatus 1 images the target person P at a constant imaging rate, a position where the eye of the target person P is captured in the plurality of eye images IMG_E generated as the time series data, is changed. For example, FIG. 14 illustrates an eye image IMG_E generated by the imaging apparatus 1 imaging the target person P before changing the imaging range, and an eye image IMG_E generated by the imaging apparatus 1 imaging the target person P after changing the imaging range. In the following description, the eye image IMG_E generated by the imaging apparatus 1 imaging the target person P before changing the imaging range, will be referred to as an eye image IMG_E (before change), and the eye image IMG_E generated by the imaging apparatus 1 imaging the target person P after changing the imaging range, will be referred to as an eye image IMG_E (after change). As illustrated in FIG. 14, the position of the eye in the eye image IMG_E (before change) is different from the position of the eye in the eye image IMG_E (after change). In this case, as illustrated in FIG. 14, the focus evaluation area FA that is set in the iris area IA in the eye image IMG_E (before change) may no longer be set in the iris area IA in the eye image IMG_E (after change). As a consequence, it is likely that the focus evaluation value of the eye image IMG_E (after change) is not properly calculated. Therefore, the area setting unit 211 may change the position of the focus evaluation area FA among the plurality of eye images IMG_E in accordance with the change in the imaging range.

For example, as illustrated in FIG. 14, the position of the focus evaluation area FA may be changed between the eye image IMG_E (before change) and the eye image IMG_E (after change) such that the focus evaluation area FA is set in the iris area IA in both the eye image IMG_E (before change) and the eye image IMG_E (after change). In this instance, the area setting unit 211 may change the position of the focus evaluation area FA on the basis of an amount of changing the imaging range. The area setting unit 211 may change the position of the focus evaluation area FA on the basis of a direction of changing the imaging range.

For example, the position of the focus evaluation area FA may be changed between the eye image IMG_E (before change) and the eye image IMG_E (after change) such that the focus evaluation area FA does not include at least one of the pupil area PA, the reflection area RA, and the eyelash area LA described in the fourth example embodiment, in both the eye image IMG_E (before change) and the eye image IMG_E (after change). For example, the position of the focus evaluation area FA may be changed between the eye image IMG_E (before change) and the eye image IMG_E (after change) such that the focus evaluation area FA is set in the lower area DA corresponding to the lower half of the iris area IA described in the fourth example embodiment, in both the eye image IMG_E (before change) and the eye image IMG_E (after change).

As described above, the information processing apparatus 2 according to the sixth example embodiment is capable of properly setting the focus evaluation area FA even in a case where the imaging range of the imaging apparatus 1 is changed. Consequently, even in a case where the imaging range of the imaging apparatus 1 is changed, the information processing apparatus 2 is capable of properly determining whether or not the eye image IMG_E is a focused image.

### (7) Seventh Example Embodiment

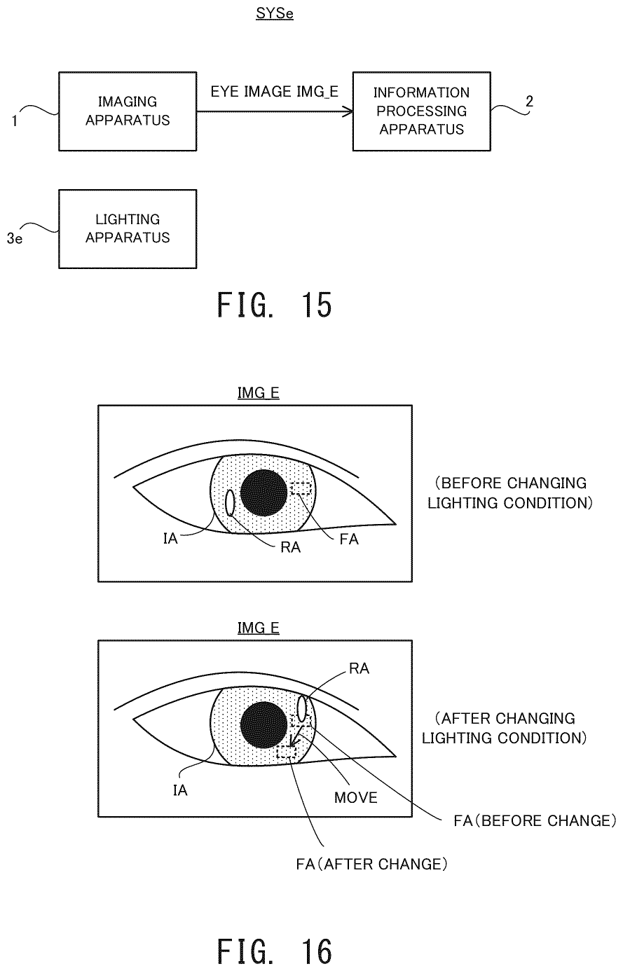

Next, with reference to FIG. 15, a seventh example embodiment of an information processing apparatus, an information processing method, and a recording medium will be described. The following describes the seventh example embodiment of the information processing apparatus, the information processing method, and the recording medium, by using an authentication system SYSe to which the seventh example embodiment of the information processing apparatus, the information processing method, and the recording medium is applied. FIG. 15 is a block diagram illustrating a configuration of the authentication system SYSe in the seventh example embodiment.

As illustrated in FIG. 15, the authentication system SYSe in the seventh example embodiment is different from at least one of the systems from the authentication system SYS in the third example embodiment to the authentication system SYSd in the sixth example embodiment, in that the authentication system SYSe includes a lighting apparatus 3e. Other features of the authentication system SYSe in the seventh example embodiment may be the same as those of at least one of the systems from the authentication system SYS in the third example embodiment to the authentication system SYSd in the sixth example embodiment.

The lighting apparatus 3e emits illumination light for illuminating the target person P. The lighting apparatus 3e illuminates the target person P with the illumination light. In this instance, the imaging apparatus 1 may image the target person P who is illuminated with the illumination light.

The lighting apparatus 3e may be configure to change a lighting condition. The lighting condition may include an emission angle of the illumination light emitted from the lighting apparatus 3e. The lighting condition may include an emission direction of the illumination light emitted from the lighting apparatus 3e. The lighting condition may include an emission position of the illumination light emitted from the lighting apparatus 3e. In a case where the lighting apparatus 3e includes a plurality of light sources (e.g., a plurality of LEDs (Light Emitting Diodes)), each of which is configured to emit the illumination light, the lighting condition may include the number of light sources that actually emit the illumination light. In a case where the lighting apparatus 3e includes a plurality of light sources, each of which is configured to emit the illumination light, the lighting condition may include the position of the light sources that actually emit the illumination light.

In addition, in a case where the lighting apparatus 3e is configured to change the lighting condition, the information processing apparatus 2 (the area setting unit 211) may set the focus evaluation area FA in accordance with the change in the lighting condition. Specifically, in a case where the lighting condition is changed in at least a part of the period in which the imaging apparatus 1 images the target person P at a constant imaging rate as described above, it is likely that the position of the reflection area RA including a reflected image of the illumination light may be changed in the plurality of eye images IMG_E generated as the time series data. For example, FIG. 16 illustrates an eye image IMG_E generated by the imaging apparatus 1 imaging the target person P before changing the lighting condition, and an eye image IMG_E generated by the imaging apparatus 1 imaging the target person P after changing the lighting condition. In the following description, the eye image IMG_E generated by the imaging apparatus 1 imaging the target person P before changing the lighting condition, will be referred to as an eye image IMG_E (before change), and the eye image IMG_E generated by the imaging apparatus 1 imaging the target person P after changing the lighting condition, will be referred to as an eye image IMG_E (after change). As illustrated in FIG. 15, the position of the reflection area RA in the eye image IMG_E (before change) is different from the position of the reflection area RA in the eye image IMG_E (after change). In this case, as illustrated in FIG. 16, the focus evaluation area FA excluding the reflection area RA in the eye image IMG_E (before change) is likely to include the reflection area RA in the eye image IMG_E (after change). As a consequence, it is likely that the focus evaluation value of the eye image IMG_E (after change) is not properly calculated. Therefore, the area setting unit 211 may change the position of the focus evaluation area FA among the plurality of eye images IMG_E in accordance with the change in the lighting condition.

For example, as illustrated in FIG. 16, the position of the focus evaluation area FA may be changed between the eye image IMG_E (before change) and the eye image IMG_E (after change) such that the focus evaluation area FA does not include the reflection area RA in both the eye image IMG_E (before change) and the eye image IMG_E (after change). In this instance, the area setting unit 211 may change the position of the focus evaluation area FA on the basis of change content of the lighting condition.

As described above, the information processing apparatus 2 according to the seventh example embodiment is capable of properly setting the focus evaluation area FA even in a case where the lighting condition of the lighting apparatus 3e is changed. Consequently, even in a case where the lighting condition of the lighting apparatus 3e is changed, the information processing apparatus 2 is capable of properly determining whether or not the eye image IMG_E is a focused image.

### (8) Supplementary Notes

With respect to the example embodiment described above, the following Supplementary Notes are further disclosed.

### [Supplementary Note 1]

An information processing apparatus including:
a setting unit that sets an evaluation area in a target image including at least a body of a target, for evaluating a focus degree of a body area including a part of the body of the target; and
a determination unit that determines whether or not the target image is a focused image in which the body area is in focus, on the basis of variance of luminance values of a plurality of pixels included in the evaluation area.

### [Supplementary Note 2]

The information processing apparatus according to Supplementary Note 1, wherein
the target image includes an eye image including an eye of the target as the body of the target, and
the body area includes an iris area including an iris of the target as a part of the body of the target.

### [Supplementary Note 3]

The information processing apparatus according to Supplementary Note 2, wherein the setting unit sets, as the evaluation area, an area that is included in the iris area and that is different from a pupil area including a pupil of the target and different from a reflection area including a reflected image of light entering the eye, in the eye image.

### [Supplementary Note 4]

The information processing apparatus according to Supplementary Note 3, wherein the setting unit identifies the reflection area on the basis of luminance values of pixels included in a sclera area included in a sclera of the target, of the eye image, and sets, as the evaluation area, an area that is different from the identified reflection area, in the eye image.

### [Supplementary Note 5]

The information processing apparatus according to any one of Supplementary Notes 1 to 4, wherein the determination unit determines that the target image is the focused image when the variance is greater than a predetermined threshold.

### [Supplementary Note 6]

The information processing apparatus according to any one of Supplementary Notes 1 to 5, wherein
the target image is generated by an imaging apparatus that is configured to image the target, and
the determination unit determines that one target image in which the variance is maximal, is the focused image, out of a plurality of target images generated by the imaging apparatus continuously imaging the target.

### [Supplementary Note 7]

The information processing apparatus according to any one of Supplementary Notes 1 to 6, wherein
the target image is generated by an imaging apparatus that is configured to image the target, and
in a case where a relative positional relation changes between an imaging range of the imaging apparatus and the target in a period in which the imaging apparatus continuously images the target to generate a plurality of target images, the setting unit changes a position of the evaluation area among the plurality of target images on the basis of a change in the relative positional relation.

### [Supplementary Note 8]

The information processing apparatus according to any one of Supplementary Notes 1 to 7, wherein
the target image is generated by an imaging apparatus that is configured to image the target, and
in a case where a lighting condition of a lighting apparatus that illuminates the target is changed in a period in which the imaging apparatus continuously images the target to generate a plurality of target images, the setting unit changes a position of the evaluation area among the plurality of target images on the basis of a change in the lighting condition.

### [Supplementary Note 9]

The information processing apparatus according to any one of Supplementary Notes 1 to 8, wherein
the setting unit sets at least a first evaluation area and a second evaluation area in the target image, and
the determination unit determines whether or not the target image is a focused image on the basis of variance of luminance values of a plurality of pixels included in the first evaluation area and the variance of luminance values of a plurality of pixels included in the second evaluation area.

### [Supplementary Note 10]

The information processing apparatus according to any one of Supplementary Notes 1 to 9, wherein the determination unit determines whether or not the target image is a focused image on the basis of variance of luminance values of the plurality of pixels that are a part of all the pixels included in the evaluation area.

### [Supplementary Note 11]

The information processing apparatus according to any one of Supplementary Notes 1 to 10, wherein
the target image is generated by an imaging apparatus that is configured to image the target, and
in a case where the imaging apparatus continuously images the target to image to generate a plurality of target images, the setting unit sets the evaluation area in a part of the plurality of target images.

### [Supplementary Note 12]

The information processing apparatus according to any one of Supplementary Notes 1 to 11, wherein the target image is generated by an imaging apparatus, which is configured to image the target, imaging the target in a period in which a relative positional relation changes between the imaging apparatus and the target.

### [Supplementary Note 13]

The information processing apparatus according to any one of Supplementary Notes 1 to 12, wherein the target image is generated by an imaging apparatus, which is configured to image the target, imaging the target in a period in which a focal length of the imaging apparatus changes.

### [Supplementary Note 14]

The information processing apparatus according to any one of Supplementary Notes 1 to 13, wherein
the target image includes an eye image including an eye of the target as the body of the target,
the body area includes an iris area including an iris of the target as a part of the body of the target, and
the setting unit sets, as the evaluation area, an area that is included in the iris area and that is different from an eyelash area including eyelashes of the target, in the eye image.

### [Supplementary Note 15]

The information processing apparatus according to any one of Supplementary Notes 1 to 14, wherein
the target image includes an eye image including an eye of the target as the body of the target,
the body area includes an iris area including an iris of the target as a part of the body of the target, and
the setting unit sets the evaluation area in a lower half of the iris area including the iris, in the eye image.

### [Supplementary Note 16]

An information processing method including:
setting an evaluation area in a target image including at least a body of a target, for evaluating a focus degree of a body area including a part of the body of the target; and
determining whether or not the target image is a focused image in which the body area is in focus, on the basis of variance of luminance values of a plurality of pixels included in the evaluation area.

### [Supplementary Note 17]

A recording medium on which a computer program that allows a computer to execute an information processing methods is recorded,
the information processing method including:
setting an evaluation area in a target image including at least a body of a target, for evaluating a focus degree of a body area including a part of the body of the target; and
determining whether or not the target image is a focused image in which the body area is in focus, on the basis of variance of luminance values of a plurality of pixels included in the evaluation area.

### [Supplementary Note 18]

An information processing apparatus including:
a setting unit that sets an evaluation area in a target image including at least a body of a target, for evaluating a focus degree of a body area including a part of the body of the target;
a determination unit that determines whether or not the target image is a focused image in which the body area is in focus, on the basis of variance of luminance values of a plurality of pixels included in the evaluation area; and
an authentication unit that authenticates the target by using the target image that is determined to be the focused image.

### [Supplementary Note 19]

An information processing method including:
setting an evaluation area in a target image including at least a body of a target, for evaluating a focus degree of a body area including a part of the body of the target;
determining whether or not the target image is a focused image in which the body area is in focus, on the basis of variance of luminance values of a plurality of pixels included in the evaluation area; and
authenticating the target by using the target image that is determined to be the focused image.

### [Supplementary Note 20]

A recording medium on which a computer program that allows a computer to execute an information processing methods is recorded,
the information processing method including:
setting an evaluation area in a target image including at least a body of a target, for evaluating a focus degree of a body area including a part of the body of the target;
determining whether or not the target image is a focused image in which the body area is in focus, on the basis of variance of luminance values of a plurality of pixels included in the evaluation area; and
authenticating the target by using the target image that is determined to be the focused image.

At least a part of the constituent components of each of the example embodiments described above can be combined with at least another part of the constituent components of each of the example embodiments described above, as appropriate. A part of the constituent components of each of the example embodiments described above may not be used. Furthermore, to the extent permitted by law, all the references (e.g., publications) cited in this disclosure are incorporated by reference as a part of the description of this disclosure.

This disclosure is allowed to be changed, if desired, without departing from the essence or spirit of this disclosure which can be read from the claims and the entire identification. An information processing apparatus, an information processing method, and a recording medium with such changes are also intended to be within the technical scope of this disclosure.

### DESCRIPTION OF REFERENCE CODES

1 Imaging apparatus
2 Information processing apparatus
21 Arithmetic apparatus
211 Area setting unit
212 In-focus determination unit
213 Iris recognition unit
1000, 2000 Information processing apparatus
1001, 2001 Setting unit
1002, 2002 Determination unit
1003, 2003 Authentication unit
SYS Authentication system
P Target person
IMG_E eye image

What is claimed is:

1. An information processing apparatus comprising:
at least one memory configured to store instructions; and
at least one processor configured to execute the instructions to:
set an evaluation area in a target image including at least a body of a target, for evaluating a focus degree of a body area including a part of the body of the target; and
determine whether or not the target image is a focused image in which the body area is in focus, on the basis of variance of luminance values of a plurality of pixels included in the evaluation area.

2. The information processing apparatus according to claim 1, wherein
the target image includes an eye image including an eye of the target as the body of the target, and
the body area includes an iris area including an iris of the target as a part of the body of the target.

3. The information processing apparatus according to claim 2, wherein the at least one processor is configured to execute the instructions to set, as the evaluation area, an area that is included in the iris area and that is different from a pupil area including a pupil of the target and different from a reflection area including a reflected image of light entering the eye, in the eye image.

4. The information processing apparatus according to claim 3, wherein the at least one processor is configured to execute the instructions to identify the reflection area on the basis of luminance values of pixels included in a sclera area included in a sclera of the target, of the eye image, and sets, as the evaluation area, an area that is different from the identified reflection area, in the eye image.

5. The information processing apparatus according to claim 1, wherein the at least one processor is configured to execute the instructions to determine that the target image is the focused image when the variance is greater than a predetermined threshold.

6. The information processing apparatus according to claim 1, wherein
the target image is generated by an imaging apparatus that is configured to image the target, and
the at least one processor is configured to execute the instructions to determine that one target image in which the variance is maximal, is the focused image, out of a plurality of target images generated by the imaging apparatus continuously imaging the target.

7. The information processing apparatus according to claim 1, wherein
the target image is generated by an imaging apparatus that is configured to image the target, and
in a case where a relative positional relation changes between an imaging range of the imaging apparatus and the target in a period in which the imaging apparatus continuously images the target to generate a plurality of target images, the at least one processor is configured to execute the instructions to change a position of the evaluation area among the plurality of target images on the basis of a change in the relative positional relation.

8. The information processing apparatus according to claim 1, wherein
the target image is generated by an imaging apparatus that is configured to image the target, and
in a case where a lighting condition of a lighting apparatus that illuminates the target is changed in a period in which the imaging apparatus continuously images the target to generate a plurality of target images, the at least one processor is configured to execute the instructions to change a position of the evaluation area among the plurality of target images on the basis of a change in the lighting condition.

9. The information processing apparatus according to claim 1, wherein
the at least one processor is configured to execute the instructions to set at least a first evaluation area and a second evaluation area in the target image, and
the at least one processor is configured to execute the instructions to determine whether or not the target image is a focused image on the basis of variance of luminance values of a plurality of pixels included in the first evaluation area and the variance of luminance values of a plurality of pixels included in the second evaluation area.

10. The information processing apparatus according to claim 1, wherein the at least one processor is configured to execute the instructions to determine whether or not the target image is a focused image on the basis of variance of luminance values of the plurality of pixels that are a part of all the pixels included in the evaluation area.

11. The information processing apparatus according to claim 1, wherein
the target image is generated by an imaging apparatus that is configured to image the target, and
in a case where the imaging apparatus continuously images the target to image to generate a plurality of target images, the at least one processor is configured to execute the instructions to set the evaluation area in a part of the plurality of target images.

12. The information processing apparatus according to claim 1, wherein the target image is generated by an imaging apparatus, which is configured to image the target, imaging the target in a period in which a relative positional relation changes between the imaging apparatus and the target.

13. The information processing apparatus according to claim 1, wherein the target image is generated by an imaging apparatus, which is configured to image the target, imaging the target in a period in which a focal length of the imaging apparatus changes.

14. The information processing apparatus according to claim 1, wherein
the target image includes an eye image including an eye of the target as the body of the target,
the body area includes an iris area including an iris of the target as a part of the body of the target, and
the at least one processor is configured to execute the instructions to set, as the evaluation area, an area that is included in the iris area and that is different from an eyelash area including eyelashes of the target, in the eye image.

15. The information processing apparatus according to claim 1, wherein
the target image includes an eye image including an eye of the target as the body of the target,
the body area includes an iris area including an iris of the target as a part of the body of the target, and
the at least one processor is configured to execute the instructions to set the evaluation area in a lower half of the iris area including the iris, in the eye image.

16. An information processing method comprising:
setting an evaluation area in a target image including at least a body of a target, for evaluating a focus degree of a body area including a part of the body of the target; and
determining whether or not the target image is a focused image in which the body area is in focus, on the basis of variance of luminance values of a plurality of pixels included in the evaluation area.

17. (canceled)

18. An information processing apparatus comprising:
at least one memory configured to store instructions; and
at least one processor configured to execute the instructions to:
set an evaluation area in a target image including at least a body of a target, for evaluating a focus degree of a body area including a part of the body of the target;
determine whether or not the target image is a focused image in which the body area is in focus, on the basis of variance of luminance values of a plurality of pixels included in the evaluation area; and
authenticate the target by using the target image that is determined to be the focused image.

19-20. (canceled)
